(19) United States
(12) Patent Application Publication
(10) Pub. No.: US 2008/0240374 A1
(43) Pub. Date: Oct. 2, 2008

(54) Method and system for linking customer conversation channels

(76) Inventors: Kelly Conway, Lake Bluff, IL (US); Douglas Brown, Austin, TX (US); Roger Warford, Hoschton, GA (US); David Gustafson, Lake Forest, IL (US); Christopher Danson, Austin, TX (US)

Correspondence Address: MCDERMOTT, WILL & EMERY LLP, 227 WEST MONROE STREET, SUITE 4400, CHICAGO, IL, 60606-5096, US

(21) Appl. No.: 11/731,479

(22) Filed: Mar. 30, 2007

(51) Int. Cl. H04M 11/00

(52) U.S. Cl. 379/67.1

(57) ABSTRACT

A method for managing communications between a customer and a contact center is provided. The communication may include voice data, interactive response data and web interaction data. Upon the receipt of an interaction identifier, related conversation data is located. Following the location of the related conversation data, the conversation data is organized sequentially. The organized conversation data may then be analyzed and distress data, behavioral assessment data and event data may be determined, either for each individual interaction segment or the entire combined experience. Following the analysis, the organized conversation data may then transfer the organized conversation data to a portal for display to a user. Further, the associated statistics can be viewed in reporting within the portal or systematically extracted from the system for further analysis.

### CROSS-REFERENCE TO RELATED APPLICATIONS

Not applicable.

### TECHNICAL FIELD

The invention relates to a method and system for linking customer conversations and the data associated with the conversations, and more particularly for storing multiple customer conversations and combining them into a single communication set for analysis.

### BACKGROUND OF THE INVENTION

It is known to utilize telephone call centers to facilitate the receipt, response and routing of incoming telephone calls relating to customer service, retention, and sales. It is also known to utilize a web based system to facilitate requests and inquiries related to customer service.

At the telephone call center, a customer is in contact with a customer service representative (“CSR”) or CSR agent who is responsible for answering the customer's inquiries and directing the customer to the appropriate individual, department, information source, or service as required to satisfy the customer's needs. At the telephone call center, the customer may also enter into an interactive voice response (“IVR”) system, whereby the customer speaks to the IVR system directly and has the call processed accordingly. It is also well known to provide a customer with a web-based system to transmit inquiries and identify possible solutions. In many cases web-based systems refer the customer to call into a telephone call center where the customer may be greeted by a CSR agent or an IVR system.

It is well known to monitor calls between a customer and agent. Accordingly call centers typically employ individuals responsible for listening to the conversation between the customer and the agent. While monitoring such calls may occur in real time, it is often more efficient and useful to record the call for later review. Information gathered from the calls is typically used to monitor the performance of the CSR agents to identify possible training needs, as well as to monitor the customer's behavior. Based on the review and analysis of the conversation, a monitor will make suggestions or recommendations to improve the quality of the customer's experience. However, the information gathered has been typically limited to the audio conversation between the caller and the agent, any data entered by the caller through the telephone key pad, and the screens viewed by the agent. As such, the monitor is restricted in thoroughly evaluating the performance of the agent and in completely understanding the experience of the caller during the telephone contact.

There is a need in customer relationship management (“CRM”) for tools useful in improving the quality of customer interactions with agents and ultimately customer relationships. In particular, a need exists for tools that will allow for monitoring a customer's complete interaction, not just a single call as a part of a larger experience.

The present invention is provided to solve the problems discussed above and other problems, and to provide advantages and aspects not provided by prior systems of this type. A full discussion of the features and advantages of the present invention is deferred to the following detailed description, which proceeds with reference to the accompanying drawings.

### SUMMARY OF THE INVENTION

According to the present invention, a computer program for managing communications between a customer and a contact center is provided. The computer program is embodied on a computer readable storage medium adapted to control a computer. The computer program comprises a plurality of code segments for performing the task. A code segment is provided for receiving an interaction identifier and for locating conversation data corresponding to the interaction identifier. The conversation data may contain voice data, interactive response data or web interaction data. Code segments are also provided for receiving the conversation data and for organizing the conversation data. The code segment for organizing the conversation data uses call timing data to arrange the conversation data in a sequential order.

The voice data may contain call type data, distress data, call timing data, customer response data or customer profile data. The voice data is associated with an interaction identifier. The interactive response data may contain call type data, distress data, call timing data, customer response data, customer profile data or customer log data. The interactive response data is associated with an interaction identifier. The web interaction data may contain inquiry type data, distress data, web timing data, customer response data, customer profile data or customer log data. The customer web interaction data is also associated with an interaction identifier.

According to one aspect of the present invention, a code segment is provided for analyzing the conversation data to assess behavioral characteristics of a caller during an interaction. The code segment for analyzing the conversation data contains a code segment for mining conversation data and applying a psychological behavioral model to the conversation data. A code segment for generating behavioral assessment data is also provided. A code segment is provided for analyzing the conversation data to assess distress characteristics of a caller during an interaction. The code segment for analyzing the conversation data includes a code segment for mining conversation data and for applying a distress model to the conversation data. A code segment is provided for generating distress data. A further code segment is provided for analyzing the conversation data to assess event characteristics of a communication between the customer and the contact center. The code segment for analyzing the conversation data contains a code segment for mining event data from the conversation data and a code segment for generating event data.

According to another aspect of the present invention, a code segment is also provided for transmitting analyzed organized conversation data to a portal server. According to one embodiment, before transmitting the analyzed conversation data to a portal server, a code segment is provided for generating a text file that is comprised of a textual translation of the conversation data.

According to another aspect of the invention, another embodiment of a computer program for managing communications between a customer and a contact center is provided. The communication includes conversation data corresponding to a stored interaction identifier. The conversation data contains voice data stored in a voice database, interactive response data stored in an interactive response database or web interaction data stored in a web interaction database. A code segment is provided for locating conversation data corresponding to a stored interaction identifier. A code segment is also provided for organizing the conversation data in a sequential order. The code segment for organizing contains an event rule code segment, a pattern rule code segment and a linking rule code segment.

The event rule code segment searches each of the voice database, the interactive response database and the web database to locate the conversation data associated with the interaction identifier. A pattern rule code segment organizes the conversation data located by the event rule code segment. The pattern rule code segment is adapted to determine whether the conversation data located by the event rule code segment in any of the voice database, the interactive response database or the web interaction database shares a common stored identifier such that the located conversation data may be organized sequentially within each of the respective databases. A first linkage rule code segment searches the voice database, the interactive response database and the web database to locate the organized conversation data associated with the stored interaction identifier. And a second linkage rule code segment for organizes the organized conversation data located by the first linkage rule code segment.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a block diagram of a call center;

FIG. 2 is a block diagram illustrating the method of linking customer conversation channels according to the present invention;

FIG. 3 is a block diagram of a computer used in connection with the present invention;

FIG. 4 is a block diagram of a telephonic communication system according to the present invention;

FIG. 5 is a block diagram of another configuration of a telephonic communication system;

FIG. 6 is a block diagram of a telephonic communication system with a multi-port PSTN module;

FIG. 7 is a flow chart illustrating a process of recording and separating a telephonic communication;

FIGS. 8-9 are graphical user interface screens of the resultant output from the process of analyzing the data of a customer communication in accordance with the present invention; and,

FIG. 10 is a flow chart of a method of generating an effectiveness score in accordance with the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

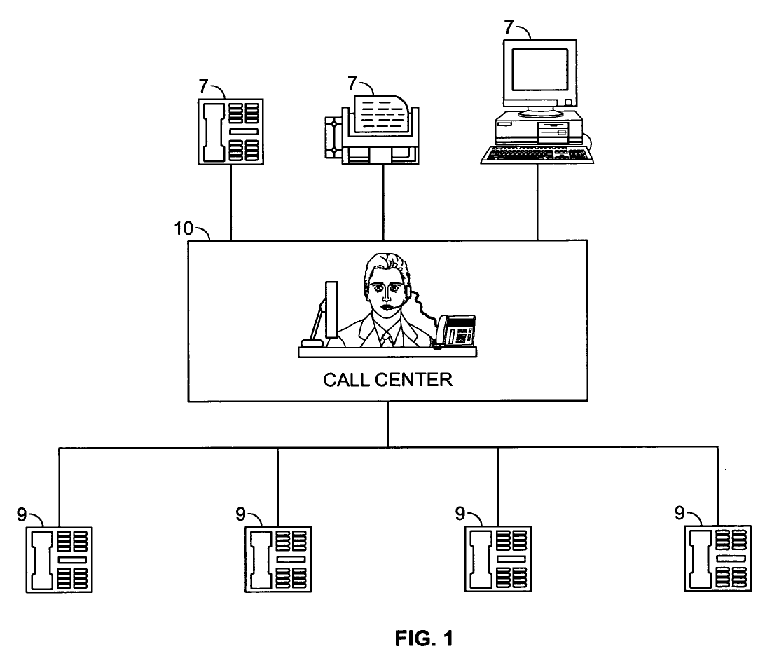

Referring to FIGS. 1-10, a method for analyzing a series of electronic communications between a customer and a contact center is provided. A “contact center” as used herein can include any facility or system server suitable for receiving and recording electronic communications from customers. Such communications can include, for example, telephone calls, facsimile transmissions, e-mails, web interactions, voice-over IP (“VoIP”), information requests, customer comments and video. It is contemplated that these communications may be transmitted by and through any type of telecommunication device and over any medium suitable for carrying data. For example, the communications may be transmitted by or through telephone lines, cable or wireless communications. As shown in FIG. 1, the contact center 10 of the present invention is adapted to receive and route telephone calls that occur between a customer (or caller) 7 and a contact center agent 9 during fulfillment of a customer/agent transaction. The present method and system for linking customer conversation channels associated with a communication between a customer 7 and a contact center 10 includes the step of receiving an interaction identifier. Conversation data corresponding to the interaction identifier is located and received. The conversation data is organized in a sequential order using timing data.

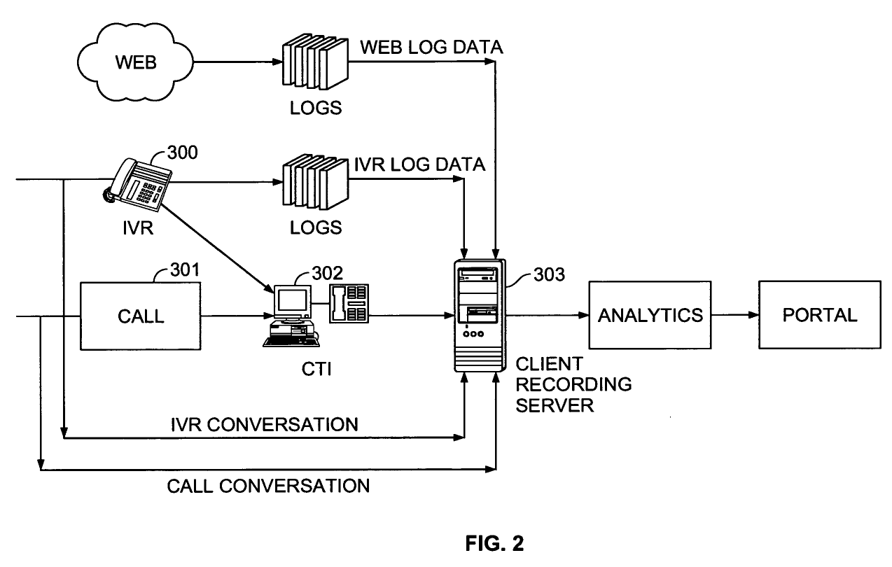

As shown in FIG. 2, one component of the system used in connection with the present method includes an interactive voice response (IVR) system 300, a telephone switch or switching system 301, a routing server 302 and a recording server 303. As will be described in further detail below, an interaction identifier associated with a telephonic communication is received. Based on the received interaction identifier, the communication is stored accordingly, either in a voice database for voice telephone calls, an interactive response database for IVR system related calls, or in a web interaction database for recording all communications that take place on a web based system. It is contemplated that the method for linking customer communications of the present invention can be implemented by a computer program. Now is described in more specific terms, the computer hardware associated with operating the computer program that may be used in connection with the present invention.

Process descriptions or blocks in figures should be understood as representing modules, segments, or portions of code which include one or more executable instructions for implementing specific logical functions or steps in the process. Alternate implementations are included within the scope of the embodiments of the present invention in which functions may be executed out of order from that shown or discussed, including substantially concurrently or in reverse order, depending on the functionality involved, as would be understood by those having ordinary skill in the art.

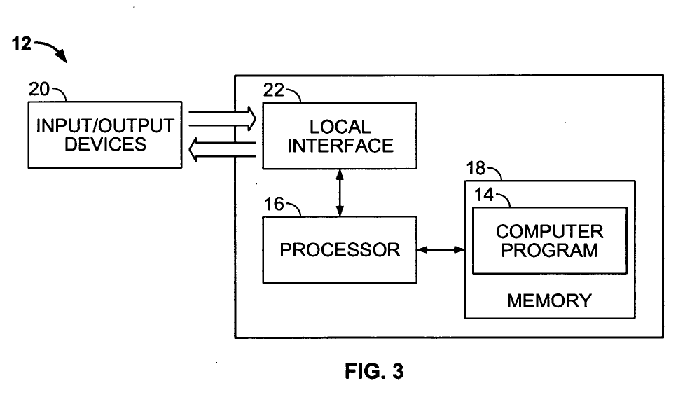

FIG. 3 is a block diagram of a computer or server 12. For purposes of understanding the hardware as described herein, the terms “computer” and “server” have identical meanings and are interchangeably used. Computer 12 includes control system 14. The control system 14 of the invention can be implemented in software (e.g., firmware), hardware, or a combination thereof. In the currently contemplated best mode, the control system 14 is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. An example of a general purpose computer that can implement the control system 14 of the present invention is shown in FIG. 3. The control system 14 may reside in, or have portions residing in, any computer such as, but not limited to, a general purpose personal computer. Therefore, computer 12 of FIG. 3 may be representative of any computer in which the control system 14 resides or partially resides.

Generally, in terms of hardware architecture, as shown in FIG. 3, the computer 12 includes a processor 16, memory 18, and one or more input and/or output (I/O) devices 20 (or peripherals) that are communicatively coupled via a local interface 22. The local interface 22 can be, for example, but not limited to, one or more buses or other wired or wireless connections, as is known in the art. The local interface 22 may have additional elements, which are omitted for simplicity, such as controllers, buffers (caches), drivers, repeaters, and receivers, to enable communications. Further, the local interface may include address, control, and/or data connections to enable appropriate communications among the other computer components.

The processor 16 is a hardware device for executing software, particularly software stored in memory 18. The processor 16 can be any custom made or commercially available processor, a central processing unit (CPU), an auxiliary processor among several processors associated with the computer 12, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×8 or Pentium series microprocessor from Intel Corporation, a PowerPC microprocessor from IBM, a Sparc microprocessor from Sun Microsystems, Inc., an 8xxx series microprocessor from Motorola Corporation, Intel Xeon (Single and Dual Core), or Intel Xeon Processor MP (Single and Dual Core).

The memory 18 can include any one or a combination of volatile memory elements (e.g., random access memory (RAM, such as DRAM, SPAM, SDRAM, etc.)) and nonvolatile memory elements (e.g., ROM, hard drive, tape, CDROM, etc.). Moreover, memory 18 may incorporate electronic, magnetic, optical, and/or other types of storage media. The memory 18 can have a distributed architecture where various components are situated remote from one another, but can be accessed by the processor 16.

The software in memory 18 may include one or more separate programs, each of which comprises an ordered listing of executable instructions for implementing logical functions. In the example of FIG. 3, the software in the memory 18 includes the control system 14 in accordance with the present invention and a suitable operating system (O/S) 24. A non-exhaustive list of examples of suitable commercially available operating systems 24 is as follows: (a) a Windows operating system available from Microsoft Corporation, including Microsoft Vista and Windows Mobile Client; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). The operating system 24 essentially controls the execution of other computer programs, such as the control system 14, and provides scheduling, input-output control, file and data management, memory management, and communication control and related services.

The control system 14 may be a source program, executable program (object code), script, or any other entity comprising a set of instructions to be performed. When a source program, the program needs to be translated via a compiler, assembler, interpreter, or the like, which may or may not be included within the memory 18, so as to operate properly in connection with the O/S 24. Furthermore, the control system 14 can be written as (a) an object oriented programming language, which has classes of data and methods, or (b) a procedure programming language, which has routines, subroutines, and/or functions, for example but not limited to, C, C++, C# (C Sharp), PHP, Pascal, Basic, Fortran, Cobol, Perl, Java, and Ada. In one embodiment, the control system 14 is written in C#. The I/O devices 20 may include input devices, for example but not limited to, a keyboard, mouse, scanner, microphone, touch screens, interfaces for various medical devices, bar code readers, stylus, laser readers, radio-frequency device readers, etc. Furthermore, the I/O devices 20 may also include output devices, for example but not limited to, a printer, bar code printers, displays, etc. Finally, the I/O devices 20 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 12 is a PC, workstation, PDA, or the like, the software in the memory 18 may further include a basic input output system (BIOS) (not shown in FIG. 3). The BIOS is a set of software routines that initialize and test hardware at startup, start the O/S 24, and support the transfer of data among the hardware devices. The BIOS is stored in ROM so that the BIOS can be executed when the computer 12 is activated.

When the computer 12 is in operation, the processor 16 is configured to execute software stored within the memory 18, to communicate data to and from the memory 18, and to generally control operations of the computer 12 pursuant to the software. The control system 14 and the O/S 24, in whole or in part, but typically the latter, are read by the processor 16, perhaps buffered within the processor 16, and then executed.

When the control system 14 is implemented in software, as is shown in FIG. 3, it should be noted that the control system 14 can be stored on any computer readable medium for use by or in connection with any computer related system or method. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory. The control system 14 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In another embodiment, where the control system 14 is implemented in hardware, the control system 14 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

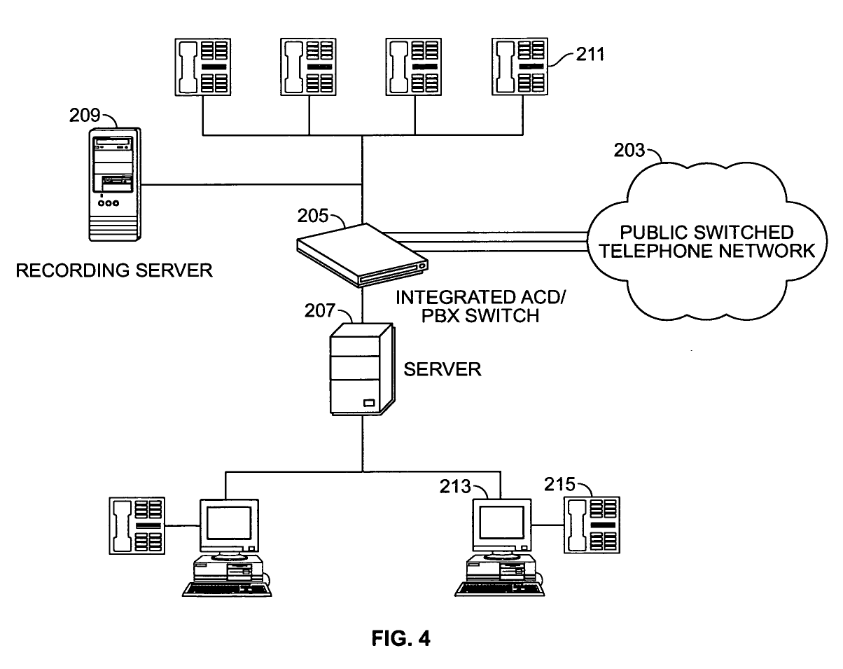

As may be seen in FIG. 4, a customer sending a telephonic signal may access a contact center 10 directly through the public switched telephone network (PSTN) 203. Alternatively, the telephonic signal can be distributed through a private branch exchange (PBX), having a public switched telephone network (PSTN) 203 connected to the PBX through a PBX switch 205. The PBX switch 205 provides an interface between the PSTN 203 and a local network. Preferably, the interface is controlled by software stored on a telephony server 207 coupled to the PBX switch 205. The PBX switch 205, using interface software, connects trunk and line station interfaces of the public switch telephone network 203 to stations of a local network or other peripheral devices contemplated by one skilled in the art. Further, in another embodiment, the PBX switch may be integrated within a telephony server 207. The stations may include various types of communication devices connected to the network, including the telephony server 207, a recording server 209, telephone stations 211, and client personal computers 213 equipped with telephone stations 215. The local network may further include fax machines and modems and other devices.

According to the present invention, computer telephony integration (“CTI”) technology is provided. In a preferred embodiment discussed herein, CTI resides on a telephony server 207. However, it will be understood by those skilled in the art that CTI can reside on its own server or at other hardware described herein. Generally, in terms of hardware architecture, the telephony server 207 includes a processor, memory, and one or more input and/or output (I/O) devices (or peripherals) that are communicatively coupled via a local interface. The processor can be any custom-made or commercially available processor, a central processing unit (CPU), an auxiliary processor among several processors associated with the telephony server 207, a semiconductor based microprocessor (in the form of a microchip or chip set), a macroprocessor, or generally any device for executing software instructions. The memory of the telephony server 207 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). The telephony server 207 may further include a keyboard and a mouse for control purposes, and an attached graphic monitor for observation of software operation. It will be understood that the telephony server may include standard CTI technology, such as that sold by Cisco, Avaya, Genesys or other provider of CTI providers.

According to one embodiment, the telephony server 207 also incorporates PBX control software to control the initiation and termination of connections between stations and via outside trunk connections to the PSTN 203. In addition, the software may monitor the status of all telephone stations 211 in real-time on the network and may be capable of responding to telephony events to provide traditional telephone service. This may include the control and generation of the conventional signaling tones such as dial tones, busy tones, ring back tones, as well as the connection and termination of media streams between telephones on the local network. Further, the PBX control software may use a multi-port module 223 and PCs to implement standard PBX functions such as the initiation and termination of telephone calls, either across the network or to outside trunk lines, the ability to put calls on hold, to transfer, park and pick up calls, to conference multiple callers, and to provide caller ID information.

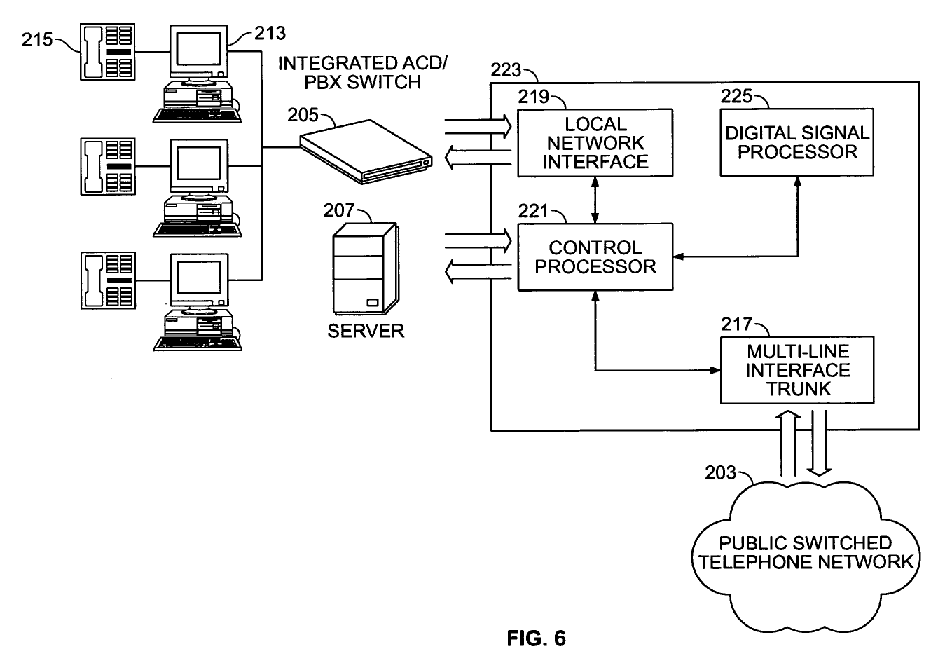

Referring to FIG. 6 in one embodiment, the telephony server 207 is equipped with multi-port PSTN module 223 having circuitry and software to implement a trunk interface 217 and a local network interface 219. The PSTN module 223 comprises a control processor 221 to manage the transmission and reception of network messages between the PBX switch 205 and the telephony server 207. The control processor 221 is also capable of directing network messages between the PBX switch 205, the local network interface 291, the telephony network server 207, and the trunk interface 217. In the one embodiment, the local network uses Transmission Control Protocol/Internet Protocol (TCP/IP), also known as Voice Over IP (VoIP). The network messages may contain computer data, telephony transmission supervision, signaling and various media streams, such as audio data and video data. The control processor 221 directs network messages containing computer data from the PBX switch 205 to the telephony network server 207 directly through the multi-port PSTN module 223.

The control processor 221 may include buffer storage and control logic to convert media streams from one format to another, if necessary, between the trunk interface 217 and local network. The trunk interface 217 provides interconnection with the trunk circuits of the PSTN 203. The local network interface 219 provides conventional software and circuitry to enable the telephony server 207 to access the local network. The buffer RAM and control logic implement efficient transfer of media streams between the trunk interface 217, the telephony server 207, the digital signal processor 225, and the local network interface 219.

The trunk interface 217 utilizes conventional telephony trunk transmission supervision and signaling protocols required to interface with the outside trunk circuits from the PSTN 203. The trunk lines carry various types of telephony signals such as transmission supervision and signaling, audio, fax, or modem data to provide plain old telephone service (POTS). In addition, the trunk lines may carry other communication formats such T1, ISDN or fiber service to provide telephony or multimedia data images, video, text or audio.

The control processor 221 manages real-time telephony event handling pertaining to the telephone trunk line interfaces, including managing the efficient use of digital signal processor resources for the detection of caller ID, DTMF, call progress and other conventional forms of signaling found on trunk lines. The control processor 221 also manages the generation of telephony tones for dialing and other purposes, and controls the connection state, impedance matching, and echo cancellation of individual trunk line interfaces on the multi-port PSTN module 223.

Preferably, conventional PBX signaling is utilized between trunk and station, or station and station, such that data is translated into network messages that convey information relating to real-time telephony events on the network, or instructions to the network adapters of the stations to generate the appropriate signals and behavior to support normal voice communication, or instructions to connect voice media streams using standard connections and signaling protocols. Network messages are sent from the control processor 221 to the telephony server 207 to notify the PBX software in the telephony server 207 of real-time telephony events on the attached trunk lines. Network messages are received from the PBX Switch 205 to implement telephone call supervision and may control the set-up and elimination of media streams for voice transmission.

The local network interface 219 includes conventional circuitry to interface with the local network. The specific circuitry is dependent on the signal protocol utilized in the local network. In one embodiment, the local network may be a local area network (LAN) utilizing IP telephony or VoIP. IP telephony integrates audio and video stream control with legacy telephony functions and may be supported through the H.323 protocol. H.323 is an International Telecommunication Union-Telecommunications protocol used to provide voice and video services over data networks. H.323 permits users to make point-to-point audio and video phone calls over a local area network. IP telephony systems can be integrated with the public telephone system through a local network interface 219, such as an IP/PBX-PSTN gateway, thereby allowing a user to place telephone calls from an enabled computer. For example, a call from an IP telephony client to a conventional telephone would be routed on the LAN to the IP/PBX-PSTN gateway. The IP/PBX-PSTN gateway translates H.323 protocol to conventional telephone protocol and routes the call over the conventional telephone network to its destination. Conversely, an incoming call from the PSTN 203 is routed to the IP/PBX-PSTN gateway and translates the conventional telephone protocol to H.323 protocol.

As noted above, PBX trunk control messages are transmitted from the telephony server 207 to the control processor 221 of the multi-port PSTN. In contrast, network messages containing media streams of digital representations of real-time voice are transmitted between the trunk interface 217 and local network interface 219 using the digital signal processor 225. The digital signal processor 225 may include buffer storage and control logic. Preferably, the buffer storage and control logic implement a first-in-first-out (FIFO) data buffering scheme for transmitting digital representations of voice audio between the local networks to the trunk interface 217. It is noted that the digital signal processor 225 may be integrated with the control processor 221 on a single microprocessor.

The digital signal processor 225 can include a coder/decoder (CODEC) connected to the control processor 221. The CODEC may be a type TCM29c13 integrated circuit made by Texas Instruments, Inc. In one embodiment, the digital signal processor 225 receives an analog or digital voice signal from a station within the network or from the trunk lines of the PSTN 203. The CODEC converts the analog voice signal into in a digital from, such as digital data packets. It should be noted that the CODEC is not used when connection is made to digital lines and devices. From the CODEC, the digital data is transmitted to the digital signal processor 225 where telephone functions take place. The digital data is then passed to the control processor 221 which accumulates the data bytes from the digital signal processor 225. It is preferred that the data bytes are stored in a first-in-first-out (FIFO) memory buffer until there is sufficient data for one data packet to be sent according to the particular network protocol of the local network. The specific number of bytes transmitted per data packet depends on network latency requirements as selected by one of ordinary skill in the art. Once a data packet is created, the data packet is sent to the appropriate destination on the local network through the local network interface 219. Among other information, the data packet contains a source address, a destination address, and audio data. The source address identifies the location the audio data originated from and the destination address identifies the location the audio data is to be sent.

The system permits bidirectional communication by implementing a return path allowing data from the local network, through the local network interface 219, to be sent to the PSTN 203 through the multi-line PSTN trunk interface 217. Data streams from the local network are received by the local network interface 219 and translated from the protocol utilized on the local network to the protocol utilized on the PSTN 203. The conversion of data may be performed as the inverse operation of the conversion described above relating to the IP/PBX-PSTN gateway. The data stream is restored in appropriate form suitable for transmission through to either a connected telephone 211, 215 or an interface trunk 217 of the PSTN module 223, or a digital interface such as a T1 line or ISDN. In addition, digital data may be converted to analog data for transmission over the PSTN 203.

Generally, the PBX switch of the present invention may be implemented with hardware or virtually. A hardware PBX has equipment located local to the user of the PBX system. The PBX switch 205 utilized may be a standard PBX manufactured by Avaya, Cisco, Siemens AG, NEC, Nortel, Toshiba, Fujitsu, Vodavi, Mitel, Ericsson, Panasonic, or InterTel. In contrast, a virtual PBX has equipment located at a central telephone service provider and delivers the PBX as a service over the PSTN 203.

As illustrated in FIG. 4 the system includes a recording server 209 for recording voice data associated with a customer communication. The recording server 209 may also be configured for recording interactive response data in an interactive response database and web interaction data in a web interaction database. The recording server 209 may be connected to a port on the local network to the PSTN trunk line. The recording server 209 is also communicably coupled to the telephony server 207 or a web hosting server (not shown), or both. The recording server 209 includes control system software, namely, recording software. The recording software of the invention can be implemented in software (e.g., firmware), hardware, or a combination thereof. In a currently contemplated preferred embodiment, the recording software is implemented in software, as an executable program, and is executed by one or more special or general purpose digital computer(s). The recording software may reside in, or have portions residing in any computer such as, but not limited to, a general purpose personal computer. While the recording server 209, is configured to store the voice data, the interactive response data and the web interaction data it is conceivable that the three databases may be stored on separate servers.

Generally, hardware architecture is the same as that discussed above and shown in FIG. 3 Specifically, the recording server 209 includes a processor, memory, and one or more input and/or output (I/O) devices (or peripherals) that are communicatively coupled via a local interface as previously described. The local interface can be, for example, but not limited to, one or more buses or other wired or wireless connections, as is known in the art. The local interface may have additional elements, which are omitted for simplicity, such as controllers, buffers (caches), drivers, repeaters, and receivers, to enable communications. Further, the local interface may include address, control, and/or data connections to enable appropriate communications among the other computer components.

In one preferred embodiment, the recording server 209 incorporates recording software for recording a telephone signal based on the source address and/or destination address of the signal. The recording server 209, while connected to the telephone signal, can be programmed to record both an oral customer communication and an interactive response communication in response to a previously described IVR system. The method utilized by the recording server 209 depends on the communication protocol utilized on the communication lines to which the recording server 209 is coupled. The signal carrying audio data of a communication between at least two users can be an analog signal or a digital signal in the form of a network message. In one embodiment, the signal is an audio data transmitted according to a signaling protocol, for example the H.323 protocol described above.

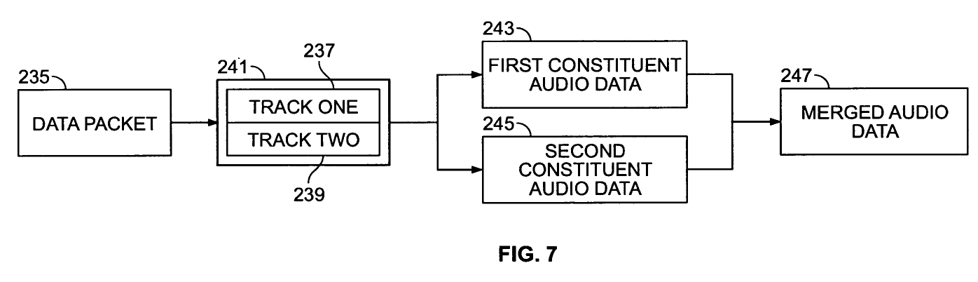

One example of a recording method that may be used in the present system is illustrated in FIG. 7 and described herein. In the embodiment of FIG. 7 when an outside caller reaches the system through the multi-line interface trunk 217, their voice signal is digitized (if needed), and converted into digital data packets 235 according to the communication protocol utilized on the local network of the system. The data packet 235 comprises a source address identifying the address of the outside caller, a destination address identifying the address of the call center agent, and first constituent audio data comprising at least a portion of the outside caller's voice. The data packet 235 can further comprise routing data identifying how the data packet 235 should be routed through the system and other relevant data. Once the data packet 235 is created, the data packet 235 is sent to the appropriate destination on the local network, such as to a call center agent, through the local network interface 219. The PBX and/or an automatic call distributor (ACD) can determine the initial communication setup, such as the connection state, impedance matching, and echo cancellation, according to predetermined criteria.

Similar to the process described above, when the call center agent speaks, their voice is digitized (if needed) and converted into digital data packet 235 according to the communication protocol utilized on the local network. The data packet 235 comprises a source address identifying the address of the call center agent, a destination address identifying the address of the outside caller, and second constituent audio data comprising at least a portion of the call center agent's voice. The data packet 235 is received by the local network interface 219 and translated from the communication protocol utilized on the local network to the communication protocol utilized on the PSTN 203. The conversion of data can be performed as described above. The data packet 235 is restored in appropriate form suitable for transmission through to either a connected telephone 211, 215 or an interface trunk 217 of the PSTN module 223, or a digital interface such as a T1 line or ISDN. In addition, digital data can be converted to analog data for transmission through the PSTN.

In a preferred embodiment, the recording server 209 receives either a data packet comprising the source address identifying the address of the outside caller, a destination address identifying the address of the call center agent, and the first constituent audio data comprising at least a portion of the outside callers voice; or a data packet comprising a source address identifying the address of the call center, a destination address identifying the address of the outside caller, and second constituent audio data comprising at least a portion of the customer's agent voice. It is understood by one of ordinary skill in the art that the recording server 209 is programmed to identify the communication protocol utilized by the local network and extract the audio data within the data packet. In one embodiment, the recording server 209 can automatically identify the utilized communication protocol from a plurality of communication protocols. The plurality of communication protocols can be stored in local memory or accessed from a remote database.

The recording server 209 preferably comprises recording software to record the communication session between the outside caller and a call center agent in a single data file in a stereo format as well as any computer programs or other computer materials used by the CSR agent while responding to the customer call. The first data file a first audio track and a second audio track. Once a telephone connection is established between an outside caller and a call center agent, the recording software creates a first data file to record the communication between the outside caller and the call center agent. It is contemplated that the entire communication session or a portion of the communication session can be recorded. It is also contemplated audio of a communication session, or portion of a communication session, can be recorded if the endpoint is an IVR (e.g., a customer to IVR conversation).

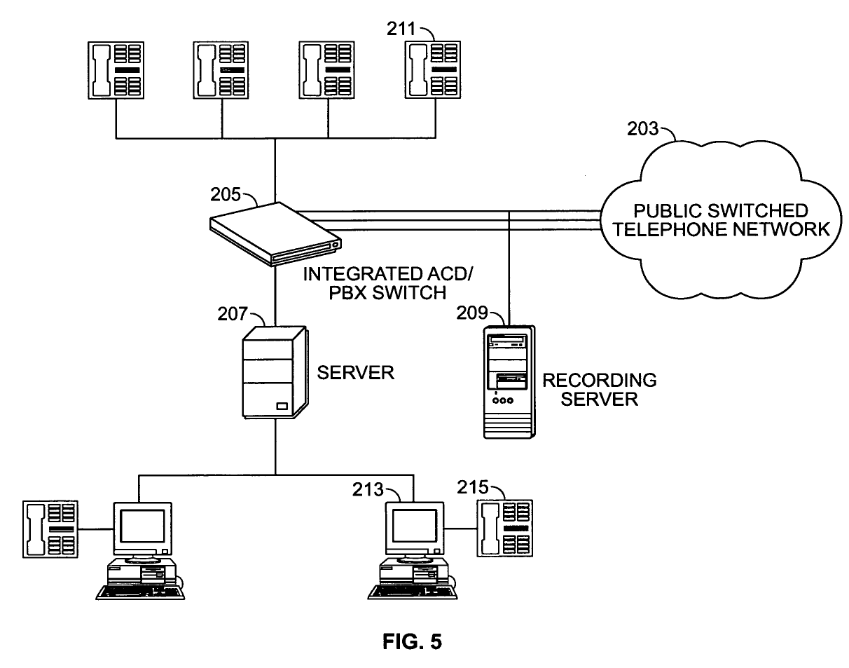

As noted above, the recording server 209 can be connected to the trunk lines of the PSTN 203 as seen in FIG. 5 The PSTN 203 can utilize a different protocol and therefore, the recording server 209 is configured to identify the communication protocol utilized by the PSTN 203, recognize the source and destination address of a signal and extract the audio data from the PSTN 203. The recording server 209 is programmed in a manner as known to one of ordinary skill in the art.

Once the communication link is terminated, the recording server 209 ends the recording session and stores the single data file having the recorded communication session in memory. After the first data file is stored in memory, the recording server 209 can extract the data from the data file. The constituent data file can be compressed before being stored in memory. The extracted data can be in the form of a digital or analog audio waveform or can be a textual translation of the audio data. It is contemplated by the present invention that, with respect to the voice data, mining and analysis in accordance with the present invention can be applied directly to voice data configured in audio format. Preferably, however, the voice data to be mined and analyzed is first translated into a text file. It will be understood by those of skill that the translation of audio to text and subsequent data mining may be accomplished by systems known in the art. It is contemplated that the data file can be further analyzed or processed. For example, among other processes and analyses, filtering techniques can be applied to the data file. Moreover, event data, such as silence periods or over-talking, can be identified by the recording server and stored with the data file using techniques known to those skilled in the art.

It is known in the art that “cradle-to-grave” recording may be used to record all information related to a particular telephone call from the time the call enters the contact center to the later of: the caller hanging up or the agent completing the transaction. The oral call information will be stored in a voice data server. All of the interactions during the call are recorded, including interaction with an IVR system, time spent on hold, data keyed through the caller's key pad, conversations with the agent, and screens displayed by the agent at his/her station during the transaction. It is further known that additional voice data may be stored in the voice data, including but not limited to, call type data, distress data, behavioral assessment data, call timing data, customer response data and customer profile data. The voice data when stored in the voice database will be stored in such a known method such that the data is associated with a interaction identifier. Associating the conversation data with a interaction identifier will allow for the data to be easily accessed later.

According to one embodiment of the present invention, the interaction with the IVR system will be stored in an interactive response database. The information stored can include the actual audio conversation and data associated with events occurring while the interaction is in IVR. For example, the stored information can include voice logs (i.e., voice recordings), buttons pushed by a customer during the interaction, the location of where the customer is transferred in response to the buttons pushed, queries prompted by the IVR, call type data, distress data, call timing data, customer response data, customer profile data, customer log data, or any other information that may be mined or harvested from an IVR interaction between a customer and a call center. The information will be stored in the interactive response database in a method such that the data may be easily associated with a interaction identifier. The association of interactive response data with an interaction identifier facilitates subsequent ease of access to the data.

Further, the recording server 209 may be used to record an internet based customer inquiry session. The data between a customer and a web system is stored in a web interaction database. All of the responses and corresponding actions taken are recorded, including timing of actions, data entered and screens displayed to the customer. It is also contemplated that additional information such as inquiry type data, web timing data, customer response data, customer profile data and customer log data are also stored in the web interaction database. The web interaction data, when stored in the web interaction database is associated with an interaction identifier, allowing the data to be accessed at a later time.

Once the voice data is stored in a voice database, the interactive response data is stored in an interactive response database and the web interaction data is stored in a web interaction database, the present invention is adapted to combine the separate forms of data into a single conversation such that the individual data forms may be mined and the entire conversation analyzed. It will be understood that “mining” as referenced herein is to be considered part of the process of analyzing data. It is also contemplated by the present invention that the mining and behavioral analysis can be conducted on a single data file or a collection of multiple files.

In one embodiment of the present invention, the voice database, the customer interactive response database and the web interaction database are each linked to a customer communication server; most preferably, providing a full view to the context of the entire customer interaction. Following the receipt of an interaction identifier, event rules are applied to locate all of the conversation data stored throughout the voice database, the interactive response database, and the web interaction database. The event rules use the interaction identifier to search through each individual database to tag all related conversation data. The interaction identifier may be any form of data that would be unique to a customer or to a conversation. For example, the interaction identifier may consist of a customer number, an account number, a telephone number, or may be information relating to the timing of a call that may be used to locate other data related to the customer interaction. However, in some cases additional resources are needed, this may include the use of the subject of the conversation or the basis of the inquiry. In combination with the time, caller identity, and call data information, the conversation data associated with the interaction identifier may be located.

After the conversation data related to a received interaction identifier is located, pattern rules are applied to the located data to organize the data associated with the interaction identifier within each of the databases. Pattern rules rely on event data and related timing data to locate the effect of a transfer on a call. The effect is that a call initially answered by an IVR and later transferred to a human CSR agent, would have both the IVR portion and the voice portion located by the event rules, and after application of the pattern rules, the IVR call portion would be placed ahead of the voice call portion in response to the different data associated with each portion of the interaction. Additional telephony information associated with the conversation is added to allow for a complete tracking method of the entire conversation. Such additional log data may include pause time before a response, delay time in transfer, delay time in response and other related timing and tracking information that may assist in developing a complete conversation within a database.

After event rules are applied to locate all conversation data associated with an interaction identifier, and pattern rules are applied to order the data sequentially within a database, linkage rules are applied to the conversation data to combine all of the organized conversations within a database to form a complete customer interaction. Initially, a first linkage rule is applied to locate all organized data associated with the interaction identifier. Following the identification of the organized conversation data within the databases, a second linkage rule is applied to combine the identified information into a sequential order of the communication. For example, the first five minutes of a voice conversation with a CSR agent, having been organized within the voice database, may now be combined with a ten minute IVR transaction that has been organized within the interactive response database. This combination across multiple databases allows for the entirety of an interaction to be reproduced. Once the conversation is successfully reconstructed, the conversation may then be analyzed as follows.

In one embodiment of the present invention, the voice data is mined for behavioral signifiers associated with a linguistic-based psychological behavioral model. Similar methods may be followed to mine information for both the interactive response conversation and the web interaction conversation. In particular, the voice data is searched for text-based keywords (i.e., behavioral signifiers) relevant to a predetermined psychological behavioral model. One preferred such psychological behavioral model and behavioral analysis is described in U.S. patent application Ser. No. 11/131,486, which is incorporated herein by reference.

The resultant behavioral assessment data derived from the analysis of the voice data may be used to evaluate qualities of a single communicant (e.g., the customer or agent behavioral type, etc.), and to analyze complete conversations as described in further detail herein. In any event, the results generated by analyzing voice data through application of a psychological behavioral model to the voice data are stored in a database for subsequent analysis of the communication.

In addition to the behavioral assessment of voice data, the method of the present invention may also employ distress analysis of voice data. Linguistic-based distress analysis is preferably conducted on both the textual translation of the voice data and the audio file containing voice data. Accordingly, linguistic-based analytic tools as well as non-linguistic analytic tools may be applied to the audio file. For example, one of skill in the art may apply spectral analysis to the audio file voice data while applying a word spotting analytical tool to the text file. Linguistic-based word spotting analysis and algorithms for identifying distress can be applied to the textual translation of the communication. Preferably, the resultant distress data is also stored in the customer history database for subsequent analysis of the communication.

It is also often desirable to analyze non-linguistic phone events occurring during the course of a conversation such as hold times, transfers, “dead-air,” overtalk, delays, etc. Accordingly, in one embodiment of the present invention, phone event data resulting from analysis of these non-linguistic events is generated. Preferably, the phone event data is generated by analyzing non-linguistic information from both the separated constituent voice data, or from the subsequently generated audio file containing at least some of the remerged audio data of the original audio waveform. It is also contemplated that the phone event data can be generated before the audio waveform is separated. The generated phone event data can also be stored in the customer history database to use in future call routing.

According to a preferred embodiment of the invention, the customer voice data is mined and analyzed across both the IVR and agent segments, as well as individually. The resulting behavioral assessment data, event data and distress data from the analyzed voice data are comparatively analyzed in view of the parameters of the psychological behavioral model to provide an assessment of a given communication. From this comparative analysis, call assessment data relating to the totality of the single call may be generated.

Generally, call assessment data is comprised of behavioral assessment data, event data and distress data. The resultant call assessment data may be subsequently viewed to provide an objective assessment or rating of the quality, satisfaction or appropriateness of the interaction between an agent and a customer. The call assessment data may generate resultant data that is also useful for characterizing the success of the interaction between a customer and an agent.

According to one embodiment of the present invention, the recording server 209 is communicably coupled to a customer history database configured to store conversation data relating to telephonic communications recorded by the recording server 209. More particularly, the customer history database is preferably a relational database that stores behavioral assessment data, event data and distress data corresponding to the interaction identifier to which the communication is associated. Additionally, any IVR usage data or web usage data by the customer may also be stored and associated with an interaction identifier. This additional data will allow for the analysis to take into consideration knowledge of data across other channels, and will aid the system in developing a complete behavioral model of a customer's interaction with a call center.

In one embodiment of the present invention, graphical user interface (“GUI”) is generated. The GUI is preferably located on a portal server. However, it is contemplated that the GUI may be disposed on any hardware or software communicably coupled to the communication system. The GUI is adapted to display a field for enabling identification of customer interactions on a display. The customer interaction event information includes call assessment data based on the psychological behavioral model applied to the analyzed constituent data of each customer interaction event. The computer program also includes a code segment for receiving input from a user for identifying at least a first customer interaction event. A code segment is also provided for displaying the customer interaction event information for the customer interaction events, as an entire interaction and individual web, IVR, or agent specific segments.

A user of the system I described above interact with the system 1 via a unique graphical user interface (“GUI”). The GUI enables the user to navigate through the system 1 to obtain desired reports and information regarding the caller interaction events stored in memory. The GUI can be part of a software program residing in whole or in part in the a computer 12, or it may reside in whole or in part on a server coupled to a computer 12 via a network connection, such as through the Internet or a local or wide area network (LAN or WAN). Moreover, a wireless connection can be used to link to the network.

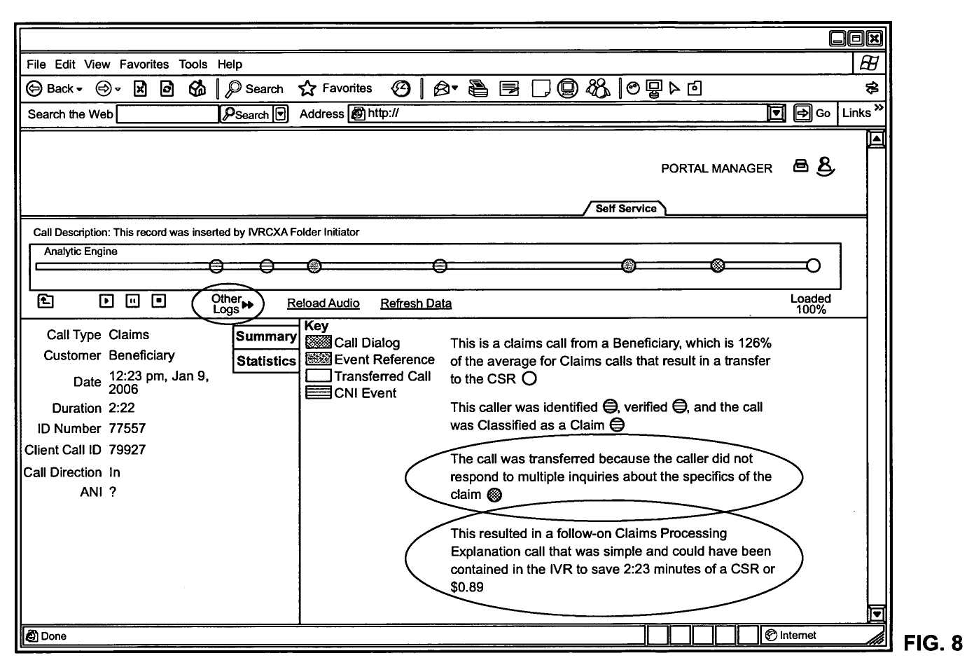

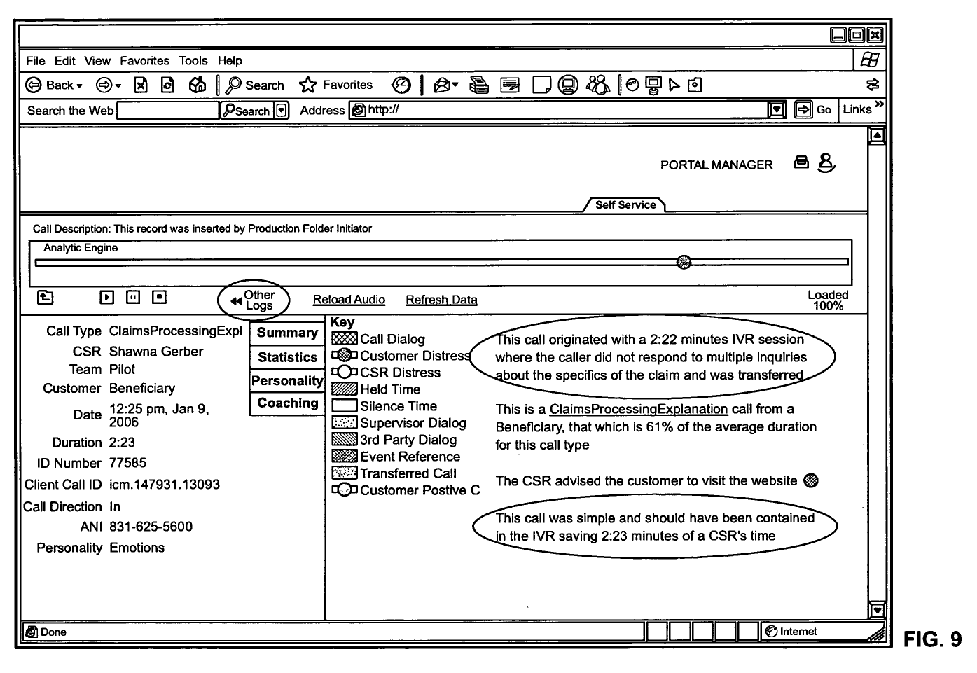

In the embodiment shown in FIGS. 8-9, the GUI enables a user of the system to locate one or more caller interaction events (i.e., calls between a caller and the call center, caller interactions with an IVR, caller interactions with a web based system), and to display information relating to the single event, or the entire conversation. In particular, the graphical user interface provides a visual field showing the results of the psychological behavioral model that was applied to the sequence of caller interactions throughout one or more interaction events. Moreover, the interface can include a link to an audio file of a selected caller interaction event, and a visual representation that tracks the portion of the caller interaction that is currently heard as the audio file is being played.

According to one aspect of the invention, the graphical user interface is incorporated in a system for identifying one or more caller interaction events and displaying a psychological behavioral model applied to the separated voice data of a customer interaction event as well as applied to the caller event information. The system comprises a computer coupled to a display and to a database of caller interaction event information. The caller interaction event information includes data resulting from application of a psychological behavioral model to a first voice data separated from an audio wave form of a caller interaction event. Additionally, the caller event information can also include additional information concerning each call, such as statistical data relating to the caller interaction event (e.g., time, date and length of call, caller identification, agent identification, hold times, transfers, etc.), and a recording of the caller interaction event.

The system also includes a processor, either at the user's computer or at another computer, such as a central server available over a network connection, for generating a graphical user interface on the display. The graphical user interface comprises a selection visual field for enabling user input of caller interaction event parameters for selection of at least a first caller interaction event and/or a plurality of caller interaction events. The caller interaction event parameters can include one or more caller interaction event identifying characteristics. These characteristics can include, for example, the caller's name or other identification information, a date range, the agent's name, the call center identification, a supervisor identifier, etc. For example, the graphical user interface can enable a user to select all caller interaction events for a particular caller; or all calls handled by a particular agent. Both examples can be narrowed to cover a specified time period or interval. The interface will display a selected caller interaction event field which provides identification of caller interaction events corresponding to the user input of caller interaction event parameters.

The conversation visual field can include a visual link to an audio file of the caller interaction event(s). Additionally, it may also include a graphical representation of the progress of the first caller interaction event that corresponds to a portion of the audio file being played. For example, the interface may show a line representing the call and a moving pointer marking the position on the line corresponding to the portion of the event being played. Additionally, the time-based representation of characteristics of the caller interaction event can include graphical or visual characteristic elements which are also displayed in the conversation visual field. Moreover, the characteristic elements are located, or have pointers to, specific locations of the graphical representation of the progress of the event corresponding to where the element was generated by the analysis.

In accordance with another embodiment of the invention, a method for identifying one or more caller interaction events and displaying an analysis of a psychological behavioral model applied to a separated voice data from the caller interaction event comprises providing a graphical user interface for displaying a first field for enabling identification of caller interaction event information on a display, the caller interaction event information including analysis data based on a psychological behavioral model applied to a first separated voice data of each caller interaction event; receiving input from a user for identifying at least a first caller interaction event; and, displaying the caller interaction event information for the first caller interaction event on the display. The step of receiving input from a user can include receiving at least one or more of a caller identifier, a call center identifier, an agent identifier, a supervisor identifier, and a date range.

The graphical user interface can be generated by a user's local computer, or from a remote server coupled to the user's computer via a network connection. In this latter instance, the method can further include creating a web page containing the graphical user interface that is downloadable to a user's computer, and downloading the page via the network connection.

The graphical user interface described can be embodied in a computer program stored on a computer readable media. The computer program would include code segments or routines to enable all of the functional aspects of the interface described or shown herein. According to one embodiment, the graphical user interface can generate a graphical representation either an entire communication or a portion of an entire communication. It is contemplated that the computer program will include a code segment for receiving user inputs that allow the user to toggle between each of the portions of the graphically represented communication segments.

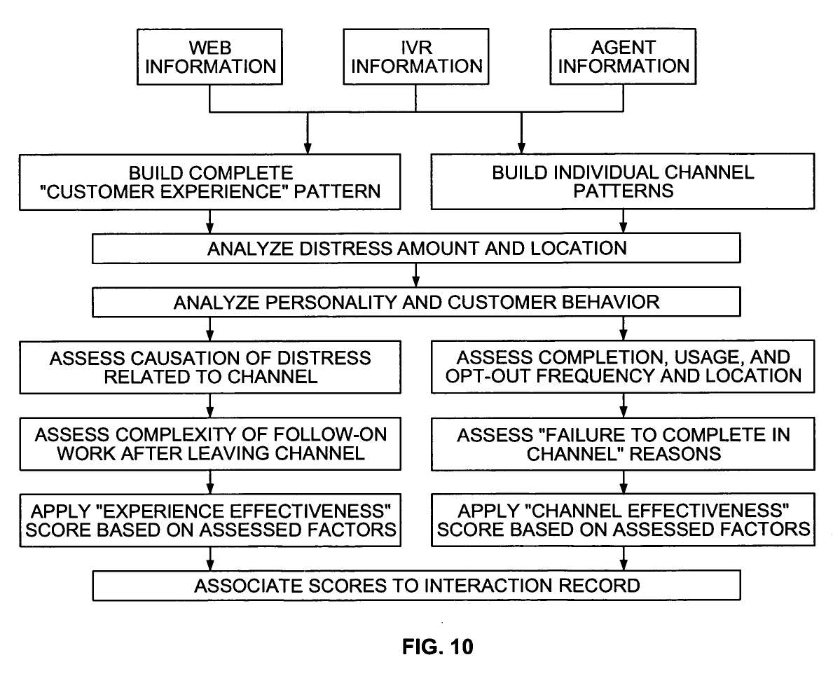

The solution of the present invention is provided such that reporting statistics can be generated to assist a call center in both overall, and very discreet, analyses of its operations. Specifically the present system generates reporting statistics about individual segments and the overall interaction across the internet, IVR, and agents. For example, in one embodiment, the system generates an effectiveness score corresponding to each of the voice data, interactive response data and web data associated with at least a portion of a communication, and in some instances the entire communication. According to one embodiment of the invention in FIG. 10, the effectiveness score is generated by building both a overall customer experience pattern and channel pattern based on voice data, interactive response data and web data.

As shown in FIG. 10, these patterns are analyzed to determine distress events associated with the patterns. Preferably, the distress events are determined using the systems and methods previously described. Similarly the patterns are analyzed to determine customer personality types and other behavioral characteristics. Again, this analysis is preferably performed in accordance with the systems and methods described herein. From these analyses, several assessments may be made about the various channels associated with a given communication or interaction. And, based on these assessments, one or both of an, experience effectiveness score and a channel effectiveness score may be derived. The system can then associated the generated scores with the communication or interaction record associated with the communication. These statistics can be generated and leveraged in reporting within the system or provided as an extract for an external system to retrieve and do further analysis.

While the specific embodiments have been illustrated and described, numerous modifications come to mind without significantly departing from the spirit of the invention and the scope of protection is only limited by the scope of the accompanying Claims.

What is claimed is:

1. A computer readable medium adapted to control a computer and comprising a plurality of code segments for managing communications between a customer and a contact center, the computer readable medium comprising:
a code segment for receiving an interaction identifier;
a code segment for locating conversation data corresponding to the interaction identifier, the conversation data comprising at least two of voice data, interactive response data and web interaction data;
a code segment for receiving the conversation data; and,
a code segment for organizing the conversation data, the code segment for organizing utilizing call timing data to arrange the conversation data in a sequential order.

2. The computer readable medium of claim 1, wherein the voice data comprises at least one of a call type data, distress data, call timing data, customer response data and customer profile data, the voice data being associated with an interaction identifier.

3. The computer readable medium of claim 1, wherein the interactive response data comprises at least one of a call type data, distress data, call timing data, customer response data and customer profile data, customer log data, the interactive response data being associated with an interaction identifier.

4. The computer readable medium of claim 1, wherein the web interaction data comprises at least one of an inquiry type data, distress data, web timing data, customer response data, customer profile data and customer log data, the customer web interaction data being associated with an interaction identifier.

5. The computer readable medium of claim 1, further comprising a code segment for analyzing the conversation data to assess behavioral characteristics of a caller during an interaction, the code segment for analyzing the conversation data comprising:
a code segment for mining conversation data and applying a psychological behavioral model to the conversation data; and,
a code segment for generating behavioral assessment data.

6. The computer readable medium of claim 1, further comprising a code segment for analyzing the conversation data to assess behavioral characteristics of a caller during an interaction, the code segment for analyzing the conversation data comprising:
a code segment for mining conversation data and applying a distress model to the conversation data; and,
a code segment for generating distress data.

7. The computer readable medium of claim 1, further comprising a code segment for analyzing the conversation data to assess event characteristics of a communication between the customer and the contact center, the code segment for analyzing the conversation data comprising:
a code segment for mining event data from the conversation data; and,
a code segment for generating event data.

8. The computer readable medium of claim 1, further comprising a code segment for transmitting the analyzed organized conversation data to a portal server.

9. The computer readable medium of claim 1, further comprising a code segment for generating a text file comprising a textual translation of the conversation data of at least one of a customer to agent communication and a customer to IVR communication, wherein the code segment generates the text file before transmitting the analyzed conversation data to a portal server.

10. A computer readable medium adapted to control a computer and comprising a plurality of code segments for managing a communication between a customer and a contact center wherein the communication includes conversation data, the conversation data corresponding to a stored interaction identifier and comprising at least one of voice data stored in a voice database, interactive response data stored in an interactive response database and web interaction data stored in a web interaction database, the computer readable medium comprising:
a code segment for locating conversation data corresponding a stored interaction identifier;
a code segment for organizing the conversation data in a sequential order, the code segment for organizing comprising:
an event rule code segment for searching each of the voice database, the interactive response database and the web database to locate substantially all conversation data associated with the received interaction identifier;
a pattern rule code segment for organizing the conversation data located by the event rule code segment, the pattern rule code segment being adapted to determine whether the conversation data located by the event rule code segment within at least one of the voice database, the interactive response database and the web interaction database shares a common stored identifier such that the located conversation data may be organized sequentially within each of the respective voice database, interactive response database and web interaction database;
a first linkage rule code segment for searching each of the voice database, the interactive response database and the web database to locate substantially all organized conversation data associated with the stored interaction identifier; and,
a second linkage rule code segment for organizing the organized conversation data located by the first linkage rule code segment.

11. The computer readable medium of claim 10, wherein the voice data comprises at least one of a call type data, distress data, call timing data, customer response data and customer profile data, the voice data being associated with an interaction identifier.

12. The computer readable medium of claim 10, wherein the interactive response data comprises at least one of a call type data, distress data, call timing data, customer response data and customer profile data, customer log data, the interactive response data being associated with an interaction identifier.

13. The computer readable medium of claim 10, wherein the web interaction data comprises at least one of an inquiry type data, distress data, web timing data, customer response data, customer profile data and customer log data, the customer web interaction data being associated with an interaction identifier.

14. The computer readable medium of claim 10, further comprising a code segment for analyzing the conversation data to assess behavioral characteristics of a caller during an interaction, the code segment for analyzing the conversation data comprising:
a code segment for mining conversation data and applying a psychological behavioral model to the conversation data; and,
a code segment for generating behavioral assessment data.

15. The computer readable medium of claim 10, further comprising a code segment for analyzing the conversation data to assess behavioral characteristics of a caller during an interaction, the code segment for analyzing the conversation data comprising:
a code segment for mining conversation data and applying a distress model to the conversation data; and,
a code segment for generating distress data.

16. The computer readable medium of claim 10, further comprising a code segment for analyzing the conversation data to assess event characteristics of a communication between the customer and the contact center, the code segment for analyzing the conversation data comprising:
a code segment for mining event data from the conversation data; and,
a code segment for generating event data.

17. The computer readable medium of claim 10, further comprising a code segment for transmitting the analyzed organized conversation data to a portal server.

18. The computer readable medium of claim 10, further comprising a code segment for generating a text file comprising a textual translation of the conversation data before transmitting the analyzed conversation data to a portal server.

19. A computer readable medium adapted to control a computer and comprising a plurality of code segments for managing communications between a customer and a contact center, wherein the communication includes conversation data, the conversation data corresponding to a stored interaction identifier and comprising at least one of voice data stored in a voice database, interactive response data stored in an interactive response database and web interaction data stored in a web interaction database, the computer readable medium comprising:
a code segment for receiving an interaction identifier;
a code segment for locating conversation data corresponding to the interaction identifier, the conversation data comprising at least two of voice data, interactive response data and web interaction data;
a code segment for receiving the conversation data;
a code segment for organizing the conversation data, the code segment for organizing the conversation data comprising:
a code segment for locating conversation data corresponding a stored interaction identifier;
a code segment for organizing the conversation data in a sequential order, the code segment for organizing comprising:
an event rule code segment for searching each of the voice database, the interactive response database and the web database to locate substantially all conversation data associated with the received interaction identifier;
a pattern rule code segment for organizing the conversation data located by the event rule code segment, the pattern rule code segment being adapted to determine whether the conversation data located by the event rule code segment within at least one of the voice database, the interactive response database and the web interaction database shares a common stored identifier such that the located conversation data may be organized sequentially within each of the respective voice database, interactive response database and web interaction database;
a first linkage rule code segment for searching each of the voice database, the interactive response database and the web database to locate substantially all organized conversation data associated with the stored interaction identifier; and,
a second linkage rule code segment for organizing the organized conversation data located by the first linkage rule code segment.

20. The computer readable medium of claim 19, further comprising a code segment for generating a channel effectiveness score associated with each of the voice data, interactive response data, web data corresponding to at least a portion of a communication.

21. The computer readable medium of claim 19, further comprising a code segment for generating an communication experience effectiveness score associated with at least a portion of a communication.

22. The computer readable medium of claim 19, further comprising a code segment for generating a graphical user interface, the graphical user interface being a graphical representation of one of either an entire communication and a portion of a communication.

23. The computer readable medium of claim 21, further comprising a code segment for receiving an input signal to toggle between a plurality of graphical representations of portions of a communication.
